(19) United States
(12) Patent Application Publication
(10) Pub. No.: US 2018/0069251 A1
(43) Pub. Date: Mar. 8, 2018

(54) MODULAR FUEL CELL SYSTEM

(71) Applicant: LG Fuel Cell Systems Inc., North Canton, OH (US)

(72) Inventor: Eric Dean, Derby (GB)

(21) Appl. No.: 15/563,740

(22) PCT Filed: Apr. 23, 2015
(86) PCT No.: PCT/GB2015/051206

§ 371 Date: Oct. 2, 2017

(51) Int. Cl. H01M 8/04089; H01M 8/249; H01M 8/2475; H01M 8/00

(52) U.S. Cl. CPC H01M 8/04097; H01M 8/249; H01M 2008/1293; H01M 8/004; H01M 8/2475

(57) ABSTRACT

There is disclosed a modular fuel cell system including a plurality of tubular segments configured to be fitted together in an end-to-end relationship to form an inner vessel of the modular fuel cell system. Each segment includes a base portion and a top portion that is separable from said base portion. The top portion and the base portion together defining an inner space for housing an integrated block of oxide fuel cells. First and second end caps are provided for sealing the respective segments at first and second opposed ends of the inner vessel, wherein said inner vessel is positioned within an outer vessel and provides a pressure boundary between an inside of the inner vessel and an inside of the outer vessel.

There is disclosed a modular fuel cell system. In particular, there is disclosed a modular high temperature fuel cell system comprising a segmented inner vessel.

In the past few decades, the realisation of diminishing global energy sources has driven an interest in identifying highly electrically efficient energy solutions while also minimising the environmental impact from the use of fossil fuels through the release of harmful emission gases. Fuel cells provide such a promising power generation means, having an electrical efficiency of at least 50%. Fuel cells do not emit harmful polluting gases making them more environmentally friendly when compared with heat engines. Fuel cells consist of an anode, a cathode and an electrolyte that allows ionic charge to flow between the anode and the cathode, while electrons are forced to take an external electrical path and thus provide an electric supply. Fuel cells are generally classified by the type of electrolyte used, for example, solid oxide (SOFCs), alkaline (AFCs), phosphoric acid (PAFCs), proton exchange membrane (PEMFCs) and molten carbonate (MCFCs), or by their operating temperature. SOFCs, for example, have operating temperatures of around 700° C. to 1000° C. Temperature variation may occur across a fuel cell, and can have negative consequences for fuel cell lifespan while also having positive effects such as improving fuel cell efficiency. Fuel cell design therefore, relies heavily on compromise of competing factors to achieve good fuel cell efficiency and lifespan.

A fuel cell converts chemical energy from a fuel i.e. the reactant, into electricity through a chemical reaction with oxygen or another oxidizing agent i.e. oxidant. Hydrogen is the most common fuel, but hydrocarbons such as natural gas and alcohols like methanol may also be used. A continuous reactant stream and a continuous oxidant stream are supplied to the fuel cell to sustain the chemical reaction and the generation of electricity. The fuel cell can produce electricity continually for as long as these inputs are supplied.

There is a drive to scale up fuel cells in order to deliver more and more power, particularly for stationary power plant applications. Desired outputs for domestic and stationary power applications are of the order of 800 W to a few megawatts. In order to deliver large power outputs, individual fuel cells are aggregated, by connecting them together in series and/or in parallel. Therefore a fuel cell element may comprise a number of individual fuel cells connected together in series. A number of those fuel cell elements may be aggregated to form a more powerful fuel cell element, and those increased power fuel cell elements may again be aggregated to form another fuel cell element. The manner of aggregation will depend on the output required and will also be affected by the fuelling and coolant requirements. Throughout the specification, the term fuel cell may refer to an individual fuel cell or a fuel cell element representing some level of aggregation. In particular, a fuel cell module refers to a number of fuel cell units connected together in parallel, where a fuel cell unit is an aggregated fuel cell element.

Currently the main variants of the solid oxide fuel cell are the tubular solid oxide fuel cell (T-SOFC), the planar solid oxide fuel cell (P-SOFC) and the monolithic solid oxide fuel cell (M-SOFC).

The tubular solid oxide fuel cell comprises a tubular solid oxide electrolyte member which has inner and outer electrodes. Typically the inner electrode is the cathode and the outer electrode is the anode. An oxidant gas is supplied to the cathode in the interior of the tubular solid oxide electrolyte member and a fuel gas is supplied to the anode on the exterior surface of the tubular solid oxide electrolyte member. (This may also be reversed.) The tubular solid oxide fuel cell allows a simple cell stacking arrangement and is substantially devoid of seals.

The monolithic solid oxide fuel cell has two variants. The first variant has a planar solid oxide electrolyte member which has electrodes on its two major surfaces. The second variant has a corrugated solid oxide electrolyte member which has electrodes on its two major surfaces. The monolithic solid oxide fuel cell is amenable to the more simple tape casting and calendar rolling fabrication processes and promises higher power densities. This type of solid oxide fuel cell requires the co-sintering of all the fuel cell layers in the monolith from their green states.

The planar solid oxide fuel cell is also amenable to tape casting and rolling fabrication processes. Currently it requires thick, 150-200 μm, self-supported solid oxide electrolyte members which limit performance.

Solid oxide fuel cells require operating temperatures of around 700° C. to around 1000° C. to achieve the required electrolyte performance within the active fuel cells.

### BRIEF SUMMARY

According to a first aspect, there is disclosed a modular fuel cell system, comprising a plurality of tubular segments configured to be fitted together in an end-to-end relationship to form an inner vessel of the modular fuel cell system, each segment comprising a base portion and a top portion that is separable from said base portion, said top portion and said base portion together defining an inner space for housing an integrated high temperature fuel cell block, and further comprising first and second end caps for sealing the respective segments at first and second opposed ends of the inner vessel, wherein said inner vessel is positioned within an outer vessel and provides a pressure boundary between an inside of the inner vessel and an inside of the outer vessel.

An advantage of the modular fuel cell system is that the integrated block may be installed in the base portion from a location above the base portion, by removing the top portion, thereby simplifying the build process of the modular fuel cell system. Having a separable top portion further provides the ability to easily access and if necessary remove or replace the integrated block without needing to dismantle the entire inner vessel by removal of the segment from the inner vessel assembly. To enable removal of any singular segment the adjacent segments are moved axially on the support frame sufficiently far apart to enable common connections between the segments to be disengaged, for example, an axial primary air feed and an exhaust duct. The base portion and the top portion may be connected together using connectors.

Optionally, the modular fuel cell system is provided with a support member, the support member being arranged to support the inner vessel in the outer vessel.

Optionally, the support member is configured to provide an access region for installing utilities, oxidant and fuel manifolds, and other essential operating and maintenance lines.

An advantage of providing an access region is that the access region is located outside of the inner vessel. The inner vessel has an operating temperature of around 700° C. to around 1000° C., whereas the space between the inner vessel and the outer vessel is configured to have an operating temperature of below approximately 150° C. The difference in temperature enables the use of readily available lower temperature grade components and technology including wires, electronic components, and connectors within the access region which results in a substantial cost saving of the modular fuel cell.

Optionally, the support member is a substantially planar frame, the substantially planar frame being provided with a number of fasteners for fastening the inner vessel to the support member. The fasteners may be provided in a three-point kinematic mount arrangement.

Optionally, the base portion is shaped to complement the shape of the support member. Preferably, the base portion the base portion has a substantially planar underside.

A substantially planar base portion shaped to complement a substantially planar frame provides an advantage of easing installation of the base portion on the support member. It further eases installation of the integrated block into the base portion of the segment and simplifies the arrangement and sealing of utilities, oxidant and fuel manifolds, and other essential operating and maintenance lines, providing the required pressure boundary between the inner vessel and outer vessel.

Optionally, the top portion has a substantially c-shaped cross-section. Optionally, wall ends of the c-shaped cross-section connect with corresponding wall ends of the base portion.

The outer vessel may be configured to operate with a greater pressure than the pressure within the inner vessel. An advantage of having a greater pressure within the outer vessel compared with the pressure within the inner vessel is that any failure of the inner pressure boundary results in cooler gases venting into the inner vessel rather than hot gases escaping into the outer vessel.

Optionally, the outer vessel is a substantially tubular vessel.

Inner surfaces of the segments may include insulation. An advantage of insulating the inner surfaces of the segments is that heat loss between the inside of the inner vessel and the outside of the inner vessel is reduced. By reducing heat loss from the inner vessel, the space between the outer vessel and the inner vessel may be maintained at a low temperature to enable the use of lower temperature grade materials in the space. Again, this reduces the overall cost of the modular fuel cell system as lower temperature grade materials such as piping, sealing rings, fasteners, are less costly than equivalent higher temperature grade materials adapted for use at operating temperatures within the inner vessel. Reducing heat loss from the inner vessel via insulation is required to maintain the thermal balance of the fuel cell system at the required system efficiency.

Preferably, the first end cap and the second end cap are provided with insulation on inner surfaces of each of the first and second end caps.

By providing insulation on the inner surfaces of the segments and end caps, the inner vessel is provided with insulation on the inner surfaces thereby limiting heat loss from the integrated blocks.

Preferably, the segments are provided with an insulating plate arranged within the segment to limit transfer of heat from one segment to an adjoining segment. An advantage of providing an insulating plate is that each integrated block is protected from heat loss between adjacent integrated blocks. This feature allows for compensation of the overall impact of one or more integrated blocks malfunctioning during operation of the modular fuel cell system, or alternatively, if one or more integrated block fails to operate at the desired operating temperature.

Optionally, the base portion and/or the top portion are provided with an oxidant manifold. The oxidant manifold is arranged within the insulation of the inner vessel. The oxidant manifold is embedded within the insulation so as to help control the temperature of the air or oxidant flowing through the oxidant manifold.

Optionally, the oxidant manifold has a cross-sectional area large enough to minimise pressure loss along the length of the inner vessel. The oxidant manifold may be arranged axially through at least two segments.

Optionally, the access region provides a number of ports for providing fuel and services to each integrated block.

Optionally, there is further provided an integrated fuel cell block comprising a fuel cell comprising an anode, a cathode and an electrolyte, a fuel supply and an oxidant supply, and recycle loops so that any unused fuel or oxidant is recycled and supplied back into the fuel supply and air supply respectively of the fuel cell, wherein the integrated fuel cell block is configured to fit into the base portion of a segment and the fuel supply is arranged to supply the fuel cell through the base portion.

The benefit of an integrated fuel cell block is that the fuel supply, oxidant supply and the recycle loops for each integrated block are independent of other integrated blocks. The result is that the fuel and oxidant ducting and passageways are incorporated within key fabrications at a relatively small scale which minimises complexity and cost of manufacturing the integrated blocks. The reduction in size of the ducting and passageways contributes to improving fuel and air distribution to each integrated block, and enabling lower pressure in the ducting and passageways. Furthermore, the overall fuel cell system is simplified and the build and subsequent maintenance costs reduced.

The integrated block enables isolation of a particular block in case of malfunction such as a leak, without the need to shut down the overall system and dismantle the entire fuel cell system. Furthermore, the integrated block allows testing of individual integrated blocks prior to installation in the inner vessel. This reduces the likelihood of installing malfunctioning integrated blocks within the inner vessel and reduces overall production time and risk.

Optionally, the oxidant supply is configured to couple with an oxidant manifold arranged within the base portion or a top portion of the segment.

Optionally, the fuel supply is configured to couple with a fuel manifold arranged through the base portion within the cooler outer vessel volume.

Optionally, the integrated block is provided with at least one insulating plate on at least one side of the integrated block.

According to a further aspect, there is provided a method for manufacturing a modular fuel cell system, the method comprising:

positioning a plurality of tubular segments in an end-to-end relationship to form an inner vessel of the modular fuel cell system, each segment comprising a base portion and a top portion that is separable from said base portion, said top portion and said base portion together defining an inner space for housing an integrated high temperature fuel cell block;

sealing the respective segments at first and second opposed ends of the inner vessel using first and second end caps and

positioning said inner vessel in an outer vessel thereby providing a pressure boundary between an inside of the inner vessel and an inside of the outer vessel.

According to a further aspect, there is disclosed a method for repairing a modular fuel cell system, the method comprising:

identifying a malfunctioning integrated high temperature fuel cell block in a modular fuel cell system by identifying a segment housing the malfunctioning integrated high temperature fuel cell block;

separating and removing a top portion from a base portion of the identified segment;

disconnecting a number of connectors or pipes arranged to connect the malfunctioning integrated high temperature fuel cell block to a number of services provided outside of the inner vessel;

removing the malfunctioning integrated high temperature fuel cell block from the base portion and replacing the malfunctioning integrated high temperature fuel cell block with a working integrated high temperature fuel cell block; and

replacing the top portion and sealing the segment to form a sealed inner vessel.

A method for repairing a modular fuel cell system, the method comprising:

identifying a defective segment within an inner vessel, the inner vessel being formed from a plurality of segments fitted together in an end-to-end relationship;

separating the segment from a support frame by disconnecting a number of connectors or pipes and by disconnecting fasteners arranged to connect the segment to adjacent segments and/or end caps in the end-to-end relationship;

removing said defective segment from the inner vessel; and

replacing said defective segment with a functioning segment and reconnecting the number of connectors or pipes and reconnecting the fasteners to form a sealed inner vessel.

Optionally, the method further comprises identifying a defective integrated high temperature fuel cell block, and identifying the corresponding segment as the defective segment.

### BRIEF DESCRIPTION OF THE DRAWINGS

Embodiments of the invention are further described hereinafter with reference to the accompanying drawings, in which:

FIG. 1 shows an overview of an example of a modular fuel cell system including an example of an integrated block, an inner vessel segment, a support frame, an inner vessel and an outer vessel;

FIG. 2 shows a three-dimensional view of an example of an inner vessel;

FIG. 3 shows a three-dimensional view of an example of an inner vessel with the top portion removed;

FIG. 4 shows an example of the of the support frame;

FIG. 5 shows a cross-sectional view through a segment;

FIG. 6 shows the underside of a segment;

FIG. 7 shows an example of a base portion showing the insulation in the base portion;

FIG. 8 an example of an integrated block installed in a base portion.

### DETAILED DESCRIPTION

In the described embodiments, like features have been identified with like numerals, albeit in some cases having increments of integer multiples of 100.

An integrated high temperature fuel cell block is also referred to as an integrated block.

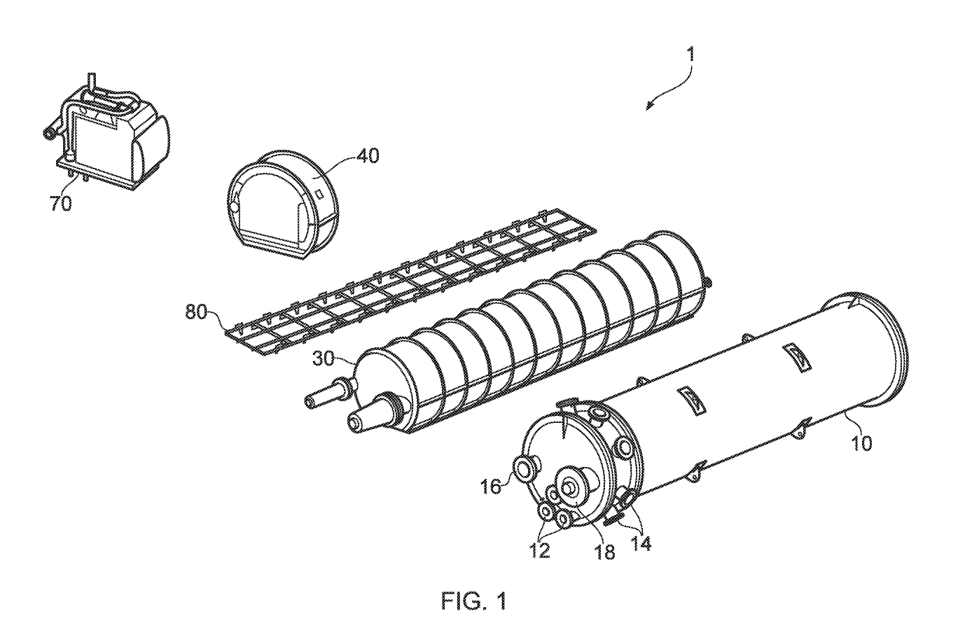

FIG. 1 shows an example of a modular fuel cell system 1 including an outer vessel 10 within which is situated an inner vessel 30 which is made up from a number of segments 40. Within each segment 40, one or more integrated fuel cell blocks 70 (integrated blocks) is provided. The inner vessel 30 is supported by a support shelf or frame 80 which also provides a support and build frame for all the fuel cell services required such as fuel supplies, power cables, instrumentation such as wires, electronic components, and connectors.

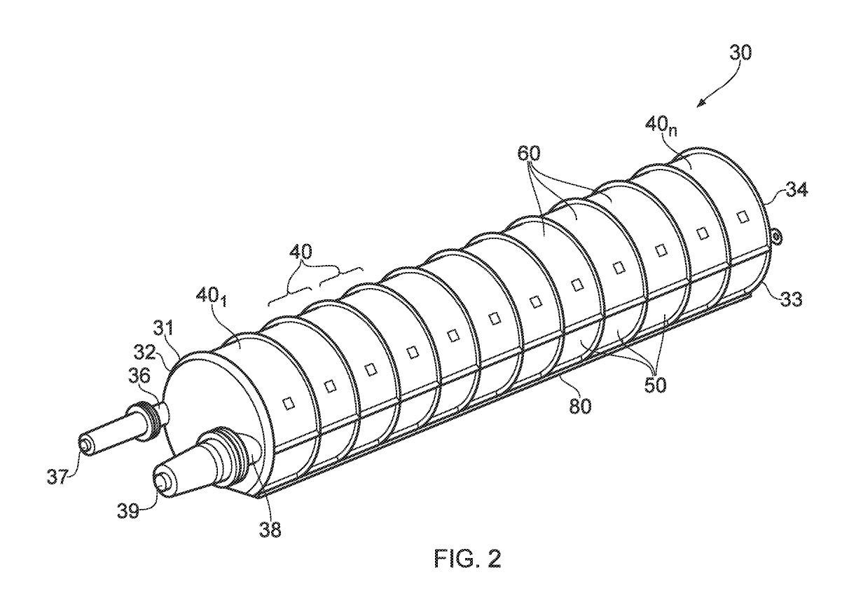

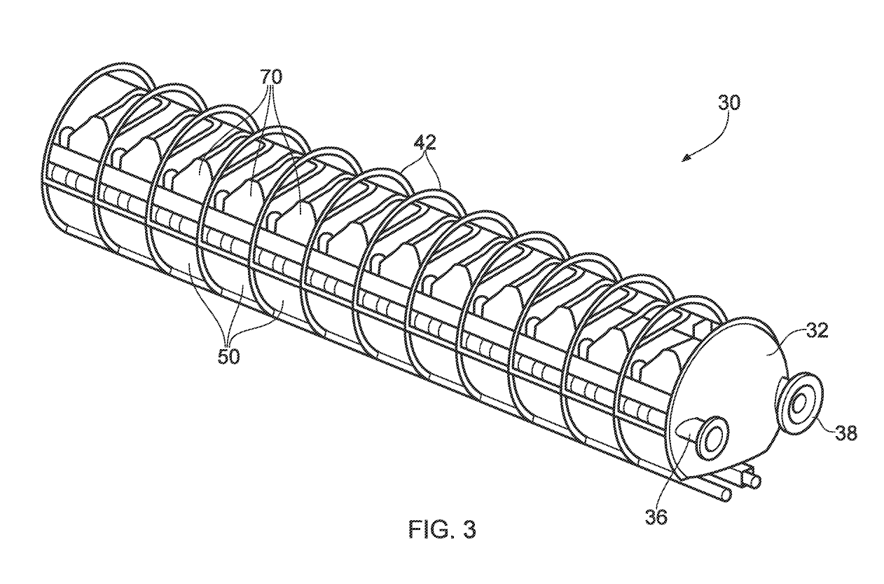

The segments 40 fit together in an end-to-end relationship to form an inner vessel 30 as shown in FIG. 2. The segments 40 are tubular. Each segment 40 includes a base portion 50 and a top portion 60. The top portion 60 is separable from the base portion 50 as shown in FIG. 3 (where the top portion 60 has been removed to reveal the integrated blocks 70 installed in the base portion 50). The base portion 50 and the top portion 60 fit together to create an inner space for housing at least one integrated block of solid oxide fuel cells 70. The top portion 60 can be removed from the base portion 50 to ease installation and assembly of the integrated fuel cell blocks 70 within the segment 40 as the integrated block 70 may be installed from the top of the segment 40 in a vertical direction.

The inner vessel 30 includes end caps 32, 34 for sealing the segments 30 at first and second opposed ends 31, 33 of the inner vessel 30. The end caps 32, 34 and segments 40 together form an inner vessel 30 as shown in FIG. 2. The end caps 32, 34 create a pressure boundary between the end segments 40₁, 40ₙ of the inner vessel 30 and the outer vessel 10. The end caps 32, 34 are provided with an oxidant port 36 to provide oxidant 37 to the segments and couple with a common oxidant manifold of the inner vessel 30, and an exhaust port 38 to remove exhaust products 39 from a common exhaust duct of the inner vessel 30.

The inner vessel 30 is positioned within an outer pressure vessel 10 and the arrangement of inner vessel 30 positioned within the outer vessel 10 provides a pressure boundary between an inside of the inner vessel 30 and an inside of the outer vessel 10.

The outer vessel 10 is a substantially cylindrical vessel having complementary ports 16, 18 for connecting to the oxidant and exhaust manifolds and a number of ports 12, 14 for utilities, services, and fuel supplies.

The inner vessel 30 is thereby formed from a number of removable segments 40. At least two removable segments 40 are required, together with two end caps 32, 34 to create a single pressure boundary that enables the installation of one or more integrated fuel cell blocks 70.

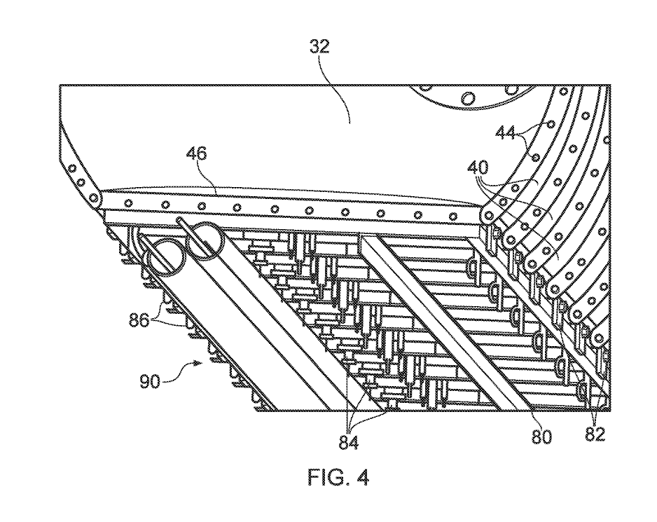

The base portion 50 and top portion 60 are joined by bolting together with a gasket 42 (see FIG. 3) using an insert in a hole 44 (see the example on FIG. 4) on one side of the bolted joint which has a shoulder to create a controlled compressed gasket thickness. This ensures an accurate assembled geometry as the scale of the assembly increases axially with additional segments 40.

In an alternative arrangement, a clip/clamp joint may be used to minimise costs. A clip/clamp joint is appropriate for the inner vessel 30 as, when in operation, there is a pressure difference between the inside of the outer vessel 10 and the inside of the inner vessel 30 so that the inner vessel 30 is in compression during operation. Furthermore, in a clip/clamp joint arrangement, the large area of the end caps 32, 34 supplies the required axial joint clamping force to maintain structural integrity of the inner vessel 30.

The inner vessel 30 provides a means for connecting multiple segments 40 in series to simplify the production of larger fuel cell systems. This provides the capability of increasing or decreasing the power output of the modular fuel cell system 1 without having to redesign the integrated block 70 or inner vessel 30 architecture.

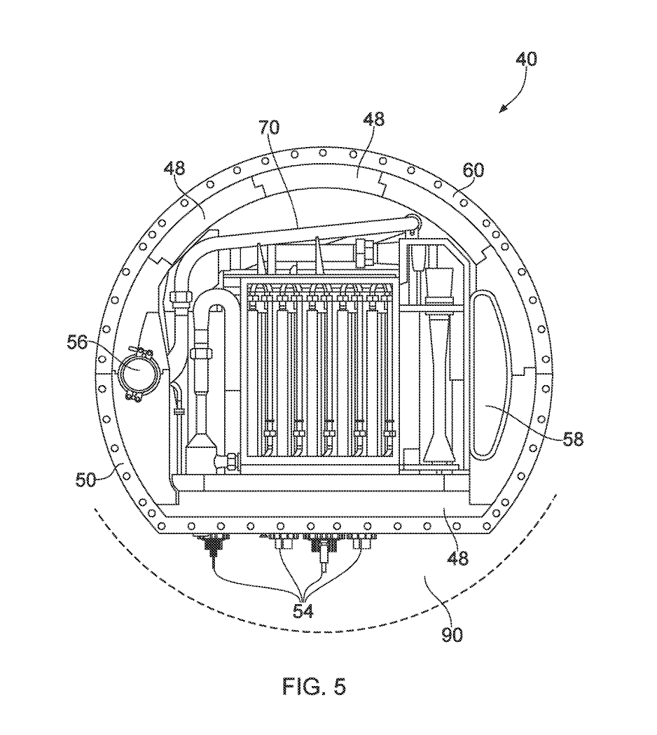

As described above, the segments 40 are formed from a base portion 50 and a top portion 60. The base portion 40 has at least one substantially planar surface 46. The planar surface 46 provides a base to support one or more integrated blocks 70 and provides an access region 90 in the cooler part of the modular fuel cell system 1. The planar surface 46 also simplifies installation of the inner vessel 30 into the outer vessel 10 via a support shelf 80 as shown in FIG. 4. The access region 90 is shown be a dashed line in FIG. 5.

The support shelf 80 is an open matrix and it is configured to slot into the outer vessel 10 and affix to inner walls of the outer vessel 10. The support shelf 80 is provided with fasteners 82 for fastening the inner vessel 30 (and therefore the segments 40) to the support shelf 82. In one example, a three-point kinematic mount system is used to fix the inner vessel 30 to the support shelf 80. In another example, alignment members are used to align the inner vessel 30 in the support shelf 80 and a further set of alignment members used to align the support shelf 80 in the outer vessel 10.

The support shelf 80 enables improved use of the access region 90 outside of the inner vessel 30 and therefore in a region cooler than the inner vessel 30 operating temperature as the support shelf 80 provides a frame for connecting fuel line and utilities 84 to the inner vessel 30. The difference in temperature provides a benefit of enabling the use of lower temperature grade components within the access region 90 which results in substantial cost savings for the production of modular fuel cell systems 1 and the use of readily available components and technologies including electronics for power management and instrumentation.

The support frame 80 provides a means for mounting individual segments for assembly and maintenance and therefore provides ease of removing malfunctioning segments 40, or malfunctioning integrated blocks 70. The support frame 80 is attached to the outer substantially planer surface 46 of the inner vessel 30 and therefore sits in a relatively cool zone of the outer vessel 10. The support frame 80 provides the architecture to locate and support a fuel supply at a relatively low temperature because the support frame 80 is in the cooler zone. The support frame 80 may also be used for interfacing the fuel cell control system with instrumentation on each integrated block 70 for control of process operations and monitoring system diagnostics.

The support frame 80 is used to locate and support the components and circuitry required to remove the power generated by the fuel cells in the integrated blocks 70 within the cooler zone.

Services attached and located on the support frame 80 in the region external to the inner vessel 30 enables ease of access for assembly and repair and provides the capability of removing an individual segment 40 from any position along the inner vessel 30.

The support frame 80 is adapted to slot into rails arranged on the inner wall of the outer vessel 10. The support frame 80 is provided with height adjustable wheels 86 to ensure correct support and load transfer between the support frame 80 and the outer vessel 10. As such, the pressure vessel 10 supports the load from the inner vessel 30 with the frame 80 being used to support all of the services, assembly and installation plus maintenance. As such the support frame is not required to support the weight of the inner vessel independently. The segments and end caps of the inner vessel are assembled and secured together on the support frame and the assembled inner vessel is inserted into the outer vessel by rolling the support frame into the outer vessel or rolling/sliding the outer vessel over the support frame. The wheels of the support frame enable ease of assembly in combination with guides on the outer vessel rails.

The base portion 50 is configured so that at least of a portion of the surface of the base portion is shaped to complement the substantially planar support shelf 80. Installation of the base portion 50 on the support shelf 80 is simplified and installation of the integrated block 70 into the base portion 50 of the segment 40 is simplified. Furthermore, the planar support shelf 80 and planar base portion 50 ease the installation and sealing of utilities, fuel manifolds, and other essential operating and maintenance lines as access to the integrated block 70 is arranged directly underneath the integrated block 70.

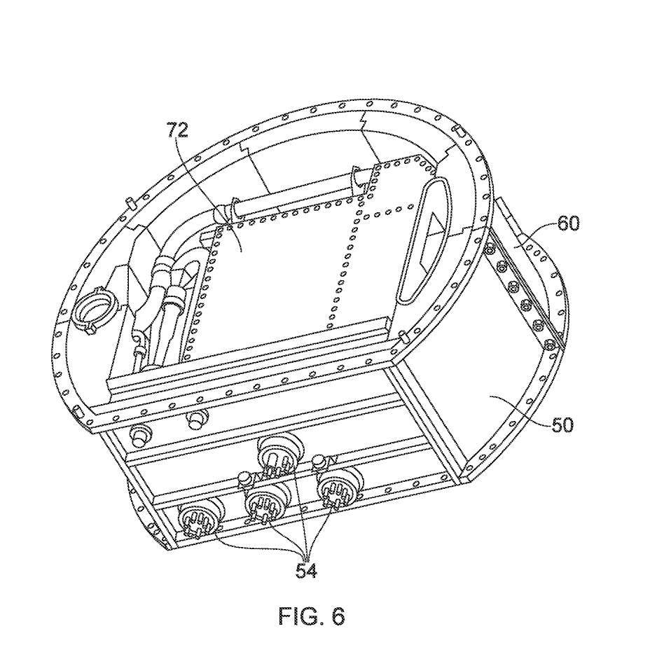

The base portion 50 is therefore provided with a number of ports 84 that provide fuel and services to each integrated fuel cell block 70 as shown in FIG. 6. The ports 84 are adapted for their predetermined use. One port is used for delivering fuel to an anode loop of each integrated block. Another port is used for delivering fuel to an auxiliary loop of each integrated block. One port is used for electrical power from each integrated block. Another port is used for instrumentation including gas-sampling lines, pressure-sampling lines, and thermocouples from each integrated block 70. This enables system control and diagnostics at the integrated block 70 level. The arrangement of the support frame 80 and planar surface 46 of the base portion 50 enable the services and utilities to be installed vertically through the base portion 50 as shown in FIGS. 5 and 6.

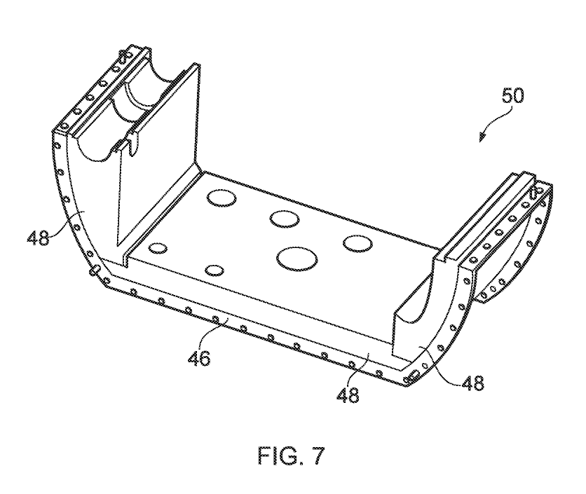

The segments 40 are provided with insulation 48 on an inner surface of the segment to limit and control heat loss from each integrated block 70. FIGS. 5, 6 and 7 show the arrangement of insulation in the segments 40. The insulation 48 also enables the management of the inner vessel wall temperature to enable the use of conventional cost effective materials for manufacture. Maintaining materials at a lower temperature increases the life span of materials, reduces mechanical and thermal stresses in the materials, reduces creep deflections and reduces corrosion. Furthermore, minimising heat loss may improve the overall efficiency of the modular fuel cell system.

Microporous ceramic insulation is used on the inner walls of the segment 40 as shown in FIGS. 5, 6, 7, and 8. The microporous ceramic insulation 48 is encapsulated in metal cladding to enable accurate shapes to be formed and to ease handling of the insulation. The metal clad microporous ceramic insulation is shaped so as to interlock and overlap as required to prevent line of sight to the metal surface of the inner vessel to minimise heat loss. Microporous ceramic insulation is the best thermal insulation currently available without needing a vacuum. Other insulating materials may be used but may require additional components such as a vacuum. If a vacuum is used, it is possible to reduce the overall thickness of the insulation, and it may be possible to reduce the overall size of the modular fuel cell system without reducing the overall power capabilities of the system, or increase the overall power without increasing the overall size of the modular fuel cell system by creating more usable internal volume.

As mentioned above, the inner vessel 30 is designed to operate with a positive pressure on its outer surface to ensure that any failure of the pressure boundary results in cooler gases venting into the containment vessel rather than hot gases escaping into the outer vessel.

An oxidant manifold 56 is provided in each segment 40. The oxidant manifold 56 supplies an equal oxidant supply to each integrated block 70 from the common leak-tight oxidant manifold 56 running axially between segments 40. The oxidant manifold 56 has a large cross section to minimize pressure loss between turbomachinery which generates the oxidant for the integrated block 70. The large cross-section oxidant manifold 56 is sized to minimize pressure loss along the length of the inner vessel. Consequently, the cross-sectional area of the oxidant manifold 56 is a function of the length of the inner vessel 30 and a function of the number of integrated blocks 70 within the modular fuel cell system. The cross-sectional area of the oxidant manifold 56 is optimised according to the required range of power output variation required for modular fuel cell system.

The oxidant manifold 56 is contained within the inner wall insulation 48 of either the base portion 50 or the top portion 60 of the segment 40 as shown in FIGS. 5, 6 and 8. The oxidant manifold 56 runs axially between segments 30 to provide oxidant at a predetermined temperature for each integrated block 70. The temperature of the oxidant flowing through the manifold 56 may be optimised by the position of the oxidant manifold within the insulation. Oxidant flowing in an oxidant pipe embedded deep within the insulation will have a lower temperature compared with oxidant flowing through an oxidant manifold located less deeply in the insulation.

Furthermore, the oxidant manifold 56 is provided with built in thermo-mechanical compliance within each segment in the form of bellows, flexible pipe or mechanical sliding joints, to enable ease of assembly and minimize thermal stresses.

The inner vessel 30 is provided with an exhaust duct 58 for exhausting air from each integrated block 70. The exhaust duct 58 has a large cross-sectional area to minimize pressure loss and pressure variation along the length of the duct 58. The exhaust duct 58 is also provided with built-in thermo-mechanical compliance within each segment 40 which can be in the form of bellows or sliding joints.

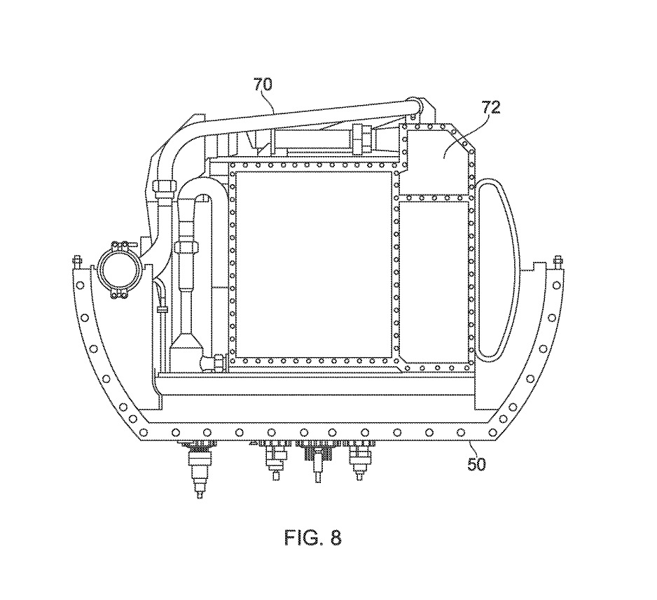

The segments 40 are each provided with a thermal barrier 72 such that when connected in series, the inner vessel 30 has thermal barriers 72 between each segment 40 and therefore each integrated block 70 as shown in FIG. 8. The thermal barrier 72 reduces the effect of a variation in an operating temperature of an individual integrated block 70 without significantly affecting adjacent segments 40. The thermal barrier 72 does not create a pressure boundary between each segment 40. The thermal barrier 72 is formed from a plate of insulating material such as microporous ceramic insulation encapsulated in metal cladding.

The end caps 32, 34 have an integrated thermal barrier to limit heat loss from the segments and to manage the end cap wall temperature to enable the use of conventional cost-effective materials for manufacture of the ports and connecting piping.

The integrated block 70 comprises a plurality of fuel cell elements. A number of integrated blocks 70 may be connected in parallel in a particular segment 40 depending upon the desired overall output of the fuel cell system 1.

Each integrated block 70 is provided with its own fuel supported on the support frame 80 and air supply via the common oxidant manifold 56. Furthermore, any unused fuel from the fuel supply and air from the air supply is recycled within the integrated block to improve efficiency such that each integrated block is an operable individual unit.

The integrated block 70 is be configured to provide around 15 kWe to around 100 kWe. In this range, the required ducting and passageways can be incorporated within key fabrications at relatively small scale to minimise complexity and cost.

The integrated fuel cell block 70 is positioned in the segment 40 and connected with at least one other segment to form the inner vessel 30. The cathode loop is open to the inner vessel volume. The cathode loop does not include an off-gas burner (OGB) and as such is typically dry because it only contains ambient moisture. The integrated fuel cell block 70 includes a cathode primary air feed connected to a cathode ejector and a fuel primary feed connected to an anode ejector. A reformer assembly and a heat exchanger assembly are also incorporated into the integrated block. An auxiliary ejector is also provided within the primary air feed.

In an alternative embodiment, the reformer exit air can be ducted to the cathode and auxiliary ejector secondary feeds with the cathode ejector exit open to the tier volume. In this case the tier volume is still “dry”.

In an alternative embodiment, both the cathode and auxiliary ejectors can be ducted with the heat exchanger outlet i.e. the exhaust flow open to the tier volume. In this configuration the tier volume will contain moisture from the auxiliary loop which contains the off-gas burner (OGB).

Introducing steam tolerant cell cathode material may eliminate the requirement for the auxiliary loop and additional heat exchanger. In this case the fuel and main cathode air streams would be locally re-cycled within the integrated block 70.

The integrated block 70 incorporates the fuel and air supply and associated recycle loops required within the individual stack blocks. This eliminates the need for tier scale recycle loops with their associated pressure losses and thermal expansion issues, and enables a single stack block or multiple stack blocks to be isolated during operation if required. This is a key advantage over previous stack and tier configurations enabling significantly improved reliability at generator module scale. Dedicated fuel and air supplies and recycle loops per block also significantly improve distribution of the fuel and air within the tier.

The integrated block 70 can be configured in a number of was by altering the open position of the cathode and auxiliary loops with each option providing alternative operating conditions and environments.

Incorporation of the ejectors and recycle loops at block scale also enables the flow path lengths to be minimised, becoming an integral part of the main reformer and heat exchanger fabricated assemblies.

One benefit of integrated blocks 70 is that they may be pre-assembled and manufactured separately from the rest of the components of the modular fuel cell system. The integrated blocks 70 may also be tested for compliance prior to installation which significantly simplifies manufacture and speeds up assembly at fuel cell vessel scale. Furthermore, individual integrated blocks 70 may to be replaced with minimal impact on remaining integrated blocks 70.

A further benefit of the access region is that services and utilities to the integrated block 70 are easily visible and accessible for build and maintenance. The low temperature access region enables the use of conventional materials and technology to supply services to the integrated blocks 70, instrumentation and power connections and enables individual fuel supplies to be easily fed to each segment which can be isolated as required during operation in the event of an issue while maintaining operation of the remaining integrated blocks 70.

The modular fuel cell system 1 is an easily scalable design for increased or reduced power output by changing the number of vessel segments 40 without significant redesign of any component.

Insulating the oxidant manifold 56 internally within the insulation 48 in the segment 40 provides a control of the temperature of the oxidant flowing through the oxidant manifold 56 when the modular fuel cell system 1 is at operating temperature. This arrangement minimises heat loss from the system 1 and eliminates the requirement for additional insulation to control the oxidant manifold temperature.

A further benefit of the integrated block 70 is improved product reliability due to ability to isolate the fuel supply to each block 70 individually, should a problem occur within the block 70 or fuel loop.

The modular fuel cell system may also be used in high temperature fuel cell systems such as solid oxide fuel cells and molten carbonate fuel cells.

It will be clear to a person skilled in the art that features described in relation to any of the embodiments described above can be applicable interchangeably between the different embodiments. The embodiments described above are examples to illustrate various features of the invention

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A modular fuel cell system, comprising a plurality of tubular segments configured to be fitted together in an end-to-end relationship to form an inner vessel of the modular fuel cell system, each segment comprising a base portion and a top portion that is separable from said base portion, said top portion and said base portion together defining an inner space for housing an integrated high temperature fuel cell block, and further comprising first and second end caps for sealing the respective segments at first and second opposed ends of the inner vessel, wherein said inner vessel is positioned within an outer vessel and provides a pressure boundary between an inside of the inner vessel and an inside of the outer vessel.

2. The modular fuel cell system according to claim 1, further provided with a support member, the support member being arranged to support the inner vessel in the outer vessel.

3. The modular fuel cell system according to claim 2, wherein the support member is configured to provide an access region for installing utilities, oxidant and fuel manifolds, electronics for power management and instrumentation, and other essential operating and maintenance lines.

4. The modular fuel cell system according to claim 2, wherein the support member is a substantially planar frame, the substantially planar frame being provided with a number of fasteners for fastening the inner vessel to the support member.

5. The modular fuel cell system according to claim 2, wherein the base portion is shaped to complement the shape of the support member.

6. The modular fuel cell system according to claim 1, wherein the base portion has a substantially planar underside.

7. The modular fuel cell system according to claim 1, wherein the outer vessel is configured to operate with a greater pressure than the pressure within the inner vessel.

8. The modular fuel cell system according to claim 1, wherein the outer vessel is a substantially tubular vessel.

9. The modular fuel cell system according to claim 1, wherein an inner surface of at least one of the plurality of segments is provided with insulation.

10. The modular fuel cell system according to claim 1, wherein the first end cap and the second end cap are provided with insulation on an inner surface of the first and second end caps.

11. The modular fuel cell system according to claim 1, wherein the segments are provided with an insulating plate arranged within the segment to limit transfer of heat from one segment to an adjoining segment.

12. The modular fuel cell system according to claim 1, wherein the base portion and/or the top portion are provided with an oxidant manifold.

13. The modular fuel cell system according to claim 12, wherein the inner vessel includes insulation and the oxidant manifold is arranged within the insulation.

14. The modular fuel cell system according to claim 13, wherein the oxidant manifold is arranged axially through at least two segments.

15. The modular fuel cell system according to claim 1, further comprising an integrated fuel cell block comprising a fuel cell comprising an anode, a cathode and an electrolyte, a fuel supply and an oxidant supply, and a recycle loop so that any unused fuel or oxidant is recycled and supplied back into the fuel supply and air supply respectively of the fuel cell, wherein the integrated fuel cell block is configured to fit onto the base portion of a segment and the fuel supply is arranged to supply the fuel cell through the base portion.

16. The modular fuel cell system according to claim 15, wherein the integrated block couples with ports in the base portion configured for installing utilities, services and other essential operating and maintenance lines to the integrated block.

17. The modular fuel cell system according to claim 15, wherein the oxidant supply is configured to couple with an oxidant manifold arranged within the base portion or a top portion of the segment.

18. The modular fuel cell system according to claim 15, wherein the fuel supply is configured to couple with a fuel manifold arranged through the base portion.

19. The modular fuel cell system according to claim 15, wherein the integrated block is provided with at least one insulating plate on at least one side of the integrated block.

20. A method for manufacturing a modular fuel cell system, the method comprising:
positioning a plurality of tubular segments in an end-to-end relationship to form an inner vessel of the modular fuel cell system, each segment comprising a base portion and a top portion that is separable from said base portion, said top portion and said base portion together defining an inner space for housing an integrated high temperature fuel cell block;
sealing the respective segments at first and second opposed ends of the inner vessel using first and second end caps; and
positioning said inner vessel in an outer vessel to provide a pressure boundary between an inside of the inner vessel and an inside of the outer vessel.

21. A method for repairing a modular fuel cell system, the method comprising:
identifying a malfunctioning integrated high temperature fuel cell block in a modular fuel cell system by identifying a segment housing the malfunctioning integrated high temperature fuel cell block;
separating and removing a top portion from a base portion of the identified segment;
disconnecting a number of connectors or pipes arranged to connect the malfunctioning integrated high temperature fuel cell block to a number of services provided outside of the inner vessel;
removing the malfunctioning integrated high temperature fuel cell block from the base portion and replacing the malfunctioning integrated high temperature fuel cell block with a working integrated high temperature fuel cell block; and
replacing the top portion and sealing the segment to form a sealed inner vessel.

22. A method for repairing a modular fuel cell system, the method comprising:
identifying a defective segment within an inner vessel, the inner vessel being formed from a plurality of segments fitted together in an end-to-end relationship;
separating the segment from a support frame by disconnecting a number of connectors or pipes and by disconnecting fasteners arranged to connect the segment to adjacent segments and/or end caps in the end-to-end relationship;
removing said defective segment from the inner vessel; and
replacing said defective segment with a functioning segment and reconnecting the number of connectors or pipes and reconnecting the fasteners to form a sealed inner vessel.

23. The method according to claim 22, wherein the method further comprises identifying a defective integrated high temperature fuel cell block, and identifying the corresponding segment as the defective segment.
